(19) United States
(12) Patent Application Publication
(10) Pub. No.: US 2013/0068403 A1
(43) Pub. Date: Mar. 21, 2013

(54) Grille Shutter Seal

(71) Applicant: SRG Global Inc., Warren, MI (US)

(72) Inventors: Patrick J. FENCHAK, Rochester Hills, MI (US); Marlon D. ANDERSON, Howell, MI (US)

(73) Assignee: SRG GLOBAL INC., Warren, MI (US)

(21) Appl. No.: 13/622,657

(22) Filed: Sep. 19, 2012

Related U.S. Application Data
(60) Provisional application No. 61/537,181, filed on Sep. 21, 2011.

(51) Int. Cl. B60K 11/08; B60K 13/02

(52) U.S. Cl. CPC B60K 11/085; B60K 13/02
USPC 160/218

(57) ABSTRACT

An assembly may include a frame member, a shutter, and a seal member. The frame member may include an opening extending therethrough. The shutter may be mounted for movement relative to the frame member between a first position allowing airflow through the opening and a second position restricting airflow through the opening. The seal member may be disposed between the frame member and the shutter. The seal member may contact the frame member and the shutter when the shutter is in the second position to restrict airflow between the frame member and the shutter.

### CROSS-REFERENCE TO RELATED APPLICATIONS

This application claims the benefit of U.S. Provisional Application No. 61/537,181, filed on Sep. 21, 2011. The entire disclosure of the above application is incorporated herein by reference.

### FIELD

The present disclosure relates to a grille shutter assembly, and more particularly, to a grille shutter assembly having a seal.

### BACKGROUND

This section provides background information related to the present disclosure and is not necessarily prior art.

Grilles and other openings, vents and ports in a vehicle can provide functional benefits including facilitating air-intake into an engine and/or providing airflow for cooling various vehicle systems and components. One or more shutter assemblies may be mounted to the vehicle proximate the grille and/or other openings in the body of the vehicle, to adjust aerodynamic characteristics and/or airflow into or out of the vehicle.

### SUMMARY

This section provides a general summary of the disclosure, and is not a comprehensive disclosure of its full scope or all of its features.

In one form, the present disclosure provides an assembly that may include a frame member, a shutter, and a seal member. The frame member may include an opening extending therethrough. The shutter may be mounted for movement relative to the frame member between a first position allowing airflow through the opening and a second position restricting airflow through the opening. The seal member may be disposed between the frame member and the shutter. The seal member may contact the frame member and the shutter when the shutter is in the second position to restrict airflow between the frame member and the shutter.

In another form, the present disclosure provides an assembly that may include a frame member, a plurality of shutters and a seal member. The frame member may define an opening. The plurality of shutters may be mounted for movement relative to the frame member between a first position allowing airflow through the opening and a second position restricting airflow through the opening. The seal member may be disposed between the frame member and the plurality of shutters and may span a width of the plurality of shutters. The seal member may contact the frame member and the plurality of shutters when the plurality of shutters are in the second position.

In yet another form, the present disclosure provides a grille shutter assembly that may include a frame member, a plurality of shutters, a first seal member, and a second seal member. The frame member may define an opening. The plurality of shutters may be mounted for movement relative to the frame member between a first position allowing airflow through the opening and a second position restricting airflow through the opening. The first seal member may be disposed on a longitudinal edge of one of the shutters and may contact an adjacent one of the shutters when the shutters are in the closed position. The second seal member may be configured to be mounted to an inner lip portion of a grille-surround and may contact the shutters when the shutters are in the second position.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a front view of a vehicle having a grille and a grille shutter assembly;

FIG. 2 is a front view of the grille shutter assembly mounted to first and second grille-surrounds and including shutters in a closed position;

FIG. 3 is a rear view of the grille shutter assembly of FIG. 2 with the shutters in an open position;

FIG. 4 is a perspective view of the shutters and an actuation mechanism of the grille shutter assembly;

FIG. 5 is a perspective view of one of the shutters; and

FIG. 6 is a cross-sectional view of one of the grille-surrounds, a sealing member, and one of the shutters in the closed position.

Corresponding reference numerals indicate corresponding parts throughout the several views of the drawings.

### DETAILED DESCRIPTION

Example embodiments will now be described more fully with reference to the accompanying drawings.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

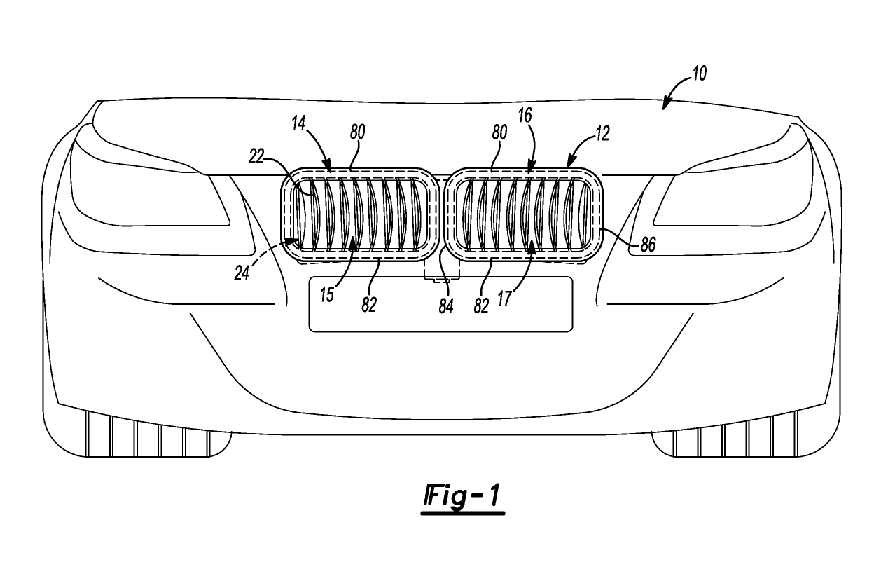

With reference to FIG. 1, a vehicle 10 is provided that may include a grille 12. The grille 12 may include first and second surrounds or grille-frames 14, 16 defining first and second openings 15, 17, respectively. Vertical bars 22 may extend vertically across the openings 15, 17 of the first and second grille-frames 14, 16. In some embodiments, the grille 12 may include horizontal bars, a grid structure and/or a lattice structure in addition to or in the alternative to the vertical bars 22. A shutter assembly 24 may be mounted to the vehicle 10 behind the grille 12 and may be operable to control airflow through the grille 12.

It should be appreciated that the vehicle 10 can be any type of vehicle having one or more openings in its body, including a car, pickup truck, sport utility vehicle, crossover vehicle, minivan, van, light commercial vehicle, heavy-duty commercial or industrial vehicle, military vehicle, construction or farm equipment or vehicle, or recreational vehicle, for example. Furthermore, it should be appreciated that the vehicle 10, regardless of the type or class of vehicle, could include an internal combustion engine, an electric motor, a hybrid powertrain (e.g., an internal combustion engine and an electric motor) and/or any other power source for powering the vehicle 10. It is also envisioned that the shutter assembly 24 could be incorporated into a boat or aircraft.

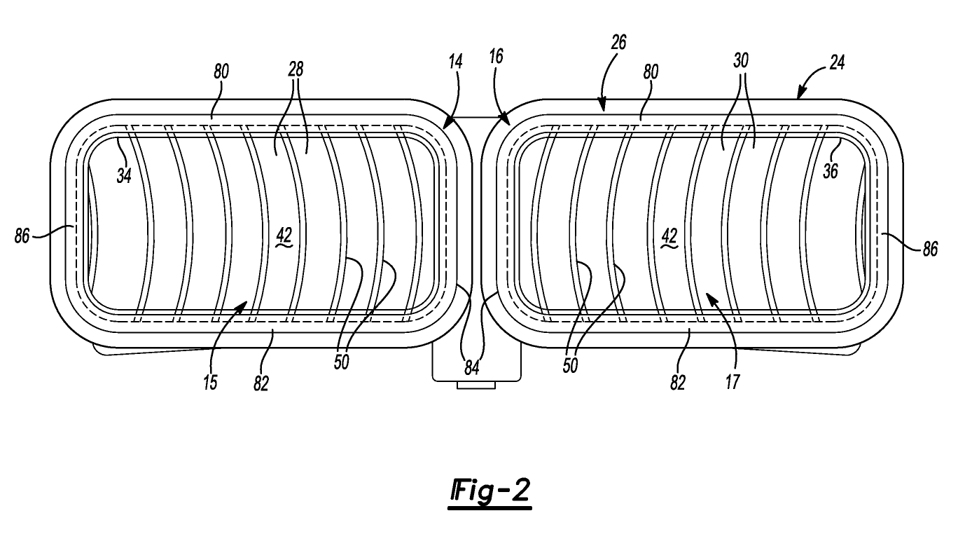

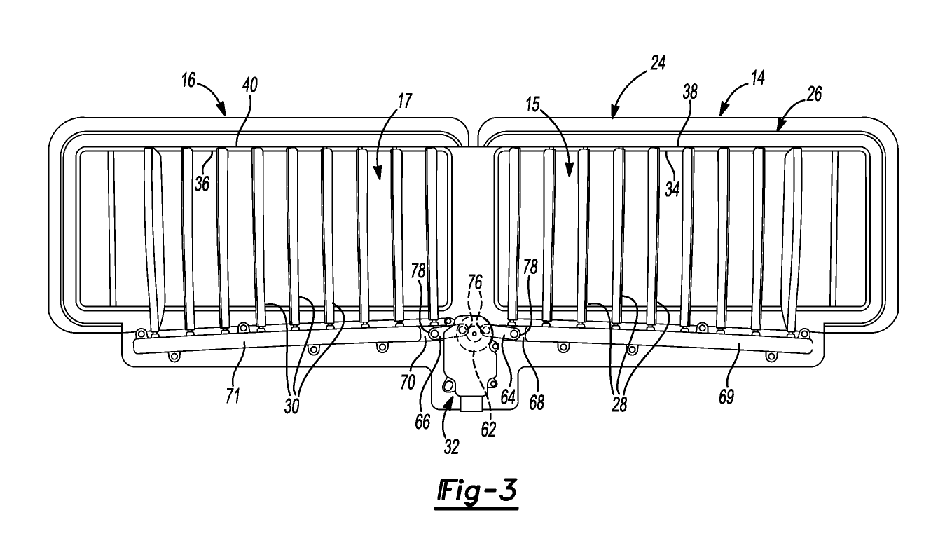

Referring now to FIGS. 1-3, the shutter assembly 24 may include a frame 26, a plurality of first shutters 28, a plurality of second shutters 30, an actuation mechanism 32, and first and second lip seals 34, 36. The frame 26 may be mounted to the first and second grille-frames 14, 16 and/or other structure of the vehicle 10 proximate the grille 12. The frame 26 may include first and second openings 38, 40 (FIG. 3) that are disposed adjacent to and generally aligned with the first and second openings 15, 17, respectively. The actuation mechanism 32 may move the first and second shutters 28, 30 relative to the frame 26 between an open position (FIG. 3) and a closed position (FIGS. 2, 4, and 6) to respectively allow and restrict airflow through the openings 15, 17, 38, 40.

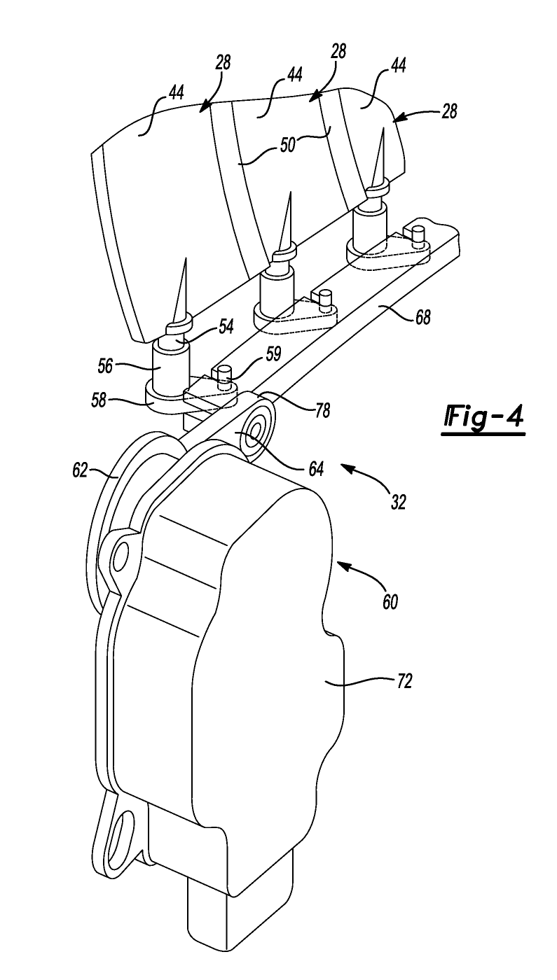

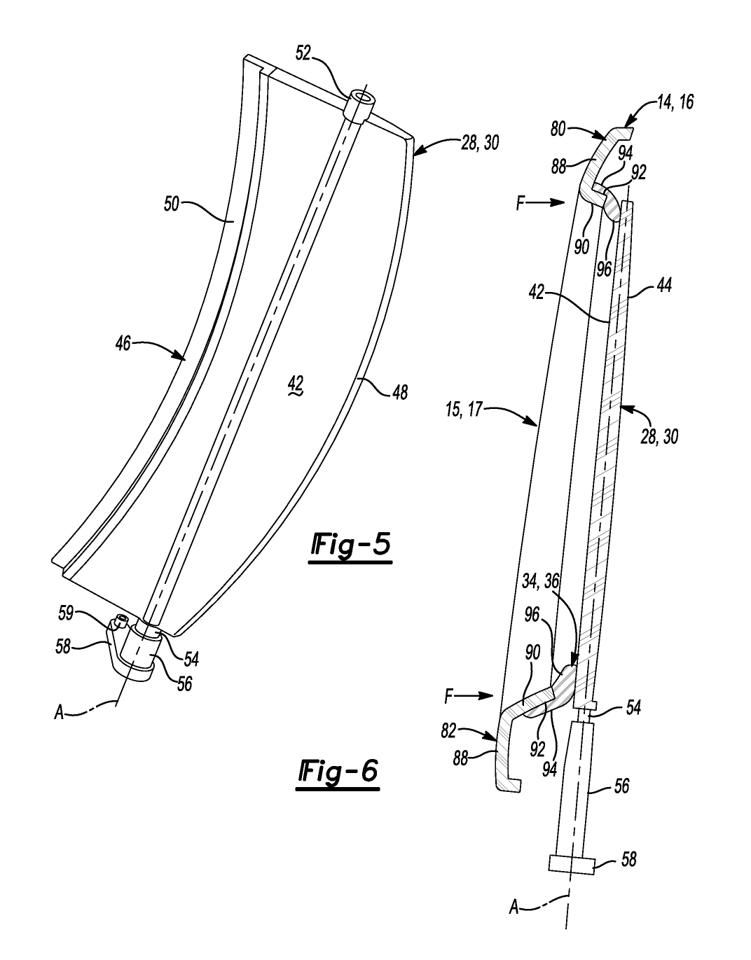

Referring now to FIGS. 4-6, the shutters 28, 30 may be formed from a polymeric material such as a nylon material or a glass-filled polypropylene, for example, and/or any other suitable material. Each of the shutters 28, 30 may include a first face 42 that faces outward from the vehicle 10 when the shutters 28, 30 are in the closed position and a second face 44 facing an interior of the vehicle 10 when the shutters 28, 30 are in the closed position. Each shutter 28, 30 may include first and second opposing edges 46, 48 extending between the first and second faces 42, 44. In some embodiments, the first edge 46 may form a concave curve, and the second edge 48 may form a convex curve. The first edge 46 may include a shutter seal 50 that may be formed from an elastomeric or polymeric material such as thermoplastic olefin (TPO), for example, and/or any other suitable material. When the shutters 28, 30 are in the closed position, the shutter seal 50 of each shutters 28, 30 may be in contact with the second face 44 of an adjacent shutter 28, 30, as shown in FIG. 4. Contact between the shutter seal 50 and the second face 44 of the adjacent shutter 28, 30 may restrict or prevent air from flowing or leaking between adjacent shutters 28, 30.

Each of the shutters 28, 30 may also include upper and lower protrusions 52, 54 attached thereto or integrally formed therewith. The upper and lower protrusions 52, 54 may be rotatably attached to the frame 26 and may define a rotational axis A about which the shutter 28, 30 may rotate relative to the frame 26. The lower protrusion 54 may be integrally formed with or attached to a stem 56 having an arm 58 extending therefrom. The arm 58 may include pins 59 connected to the actuation mechanism 32, as shown in FIG. 4.

Referring now to FIGS. 3 and 4, the actuation mechanism 32 may include an actuator 60, a drive wheel 62, first and second connecting links 64, 66, and first and second drive arms 68, 70. The actuator 60 may include a motor (not shown), a motor housing 72, and an output shaft (not shown) that is rotationally driven by the motor and protrudes through the motor housing 72. The drive wheel 62 may be connected to the output shaft.

Each of the first and second connecting links 64, 66 may include first and second ends 76, 78. The first ends 76 of the connecting links 64, 66 may be coupled to the drive wheel 62. The second end 78 of the first connecting link 64 may be coupled to the first drive arm 68, and the second end 78 of the second connecting link 66 may be coupled to the second drive arm 70. The first and second drive arms 68, 70 may be substantially encased within first and second drive-arm housings 69, 71, respectively. The drive wheel 62 may cooperate with the connecting links 64, 66 to act as a crank to convert rotational motion of the output shaft to linear motion of the drive arms 68, 70. The drive arms 68, 70 may reciprocate within the drive-arm housings 69, 71. The drive arms 68, 70 are coupled to the pins 59 of the shutters 28, 30 such that linear motion of the drive arms 68, 70 causes corresponding rotational motion of the shutters 28, 30 about the rotational axis A between the open and closed positions.

It will be appreciated that in other embodiments, the actuation mechanism 32 could be otherwise constructed or configured to move the shutters 28, 30 between the open and closed positions. In some embodiments, the actuation mechanism 32 could be configured to open and close the first and second shutters 28, 30 concurrently with each other. In some embodiments, the actuation mechanism 32 could be configured to move the first and second shutters 28, 30 independently of each other. In some embodiments, the actuation mechanism 32 could be constructed similar to the mechanism disclosed in U.S. patent application Ser. No. 13/079,372, the disclosure of which is incorporated herein by reference.

With reference to FIGS. 2, 3, and 6, the first and second lip seals 34, 36 may be attached to the first and second grille-frames 14, 16, respectively. The first and second grille-frames 14, 16 may each include an upper portion 80, a lower portion 82 and first and second side portions 84, 86 connecting the upper and lower portions 80, 82. The grille-frames 14, 16 may include generally hollow cross sections (shown in FIG. 6) formed by a main body portion 88 and an inner lip portion 90. The inner lip portion 90 of the first and second grille-frames 14, 16 may define the peripheries of the first and second openings 15, 17, respectively. The inner lip portion 90 may extend at an angle generally toward the shutters 28, 30. The inner lip portion 90 may include a seal-attachment surface 92 facing generally away from its respective opening 15, 17.

The first and second lip seals 34, 36 may be formed from a resiliently flexible and compressible elastomeric or polymeric material such as thermoplastic olefin, for example, and/or any other suitable material. In some embodiments, each of the first and second lip seals 34, 36 may be continuous members extending along the entire inner lip portion 90 of the respective grille-frame 14, 16. In some embodiments, a separate and discrete lip seal may be attached to each of the upper and lower portions 80, 82 of each grille-frame 14, 16.

The lip seals 34, 36 include a cross section having a fixed end 94 and a free end 96. The fixed end 94 may be fixedly attached to the seal-attachment surface 92 of the respective grille-frame 14, 16, and the free end 96 may extend therefrom generally toward the respective shutters 28, 30. As shown in FIGS. 2 and 6, when the shutters 28, 30 are in the closed position, the lip seals 34, 36 may extend across widths of the first faces 42 of the shutters 28, 30. The first faces 42 of at least some of the shutters 28, 30 may contact the free ends 96 of the lip seals 34, 36 when the shutters 28, 30 are in the closed position and may compress and/or deflect the lip seals 34, 36 toward the front end of the vehicle 10 to form a seal therebetween to restrict or prevent air from flowing between the inner lip portion 90 and the shutters 28, 30. When the vehicle 10 is moving in a forward direction, wind resistance may exert a force F on the lip seals 34, 36 that biases the free ends 96 of the lip seals 34, 36 against the faces 42 of the shutters 28, 30. In this manner, the force F may improve the sealed relationship between the lip seals 34, 36 and the shutters 28, 30 to further restrict or prevent air from flowing or leaking between the inner lip portion 90 of the grille-frames 14, 16 and the shutters 28, 30 when the shutters 28, 30 are in the closed position.

While the shutter assembly 24 is described above as being associated with the grille 12, it will be appreciated that in other embodiments, the shutter assembly 24 could be configured to control airflow through any other vent, port or opening in the vehicle 10. While the grille 12 is described above as having first and second grille-frames 14, 16 and vertical bars 22, it will be appreciated that the grille 12 could have any other configuration or design. In some embodiments, the grille 12 could include only a single grille-frame and a single opening and the shutter assembly 24 may include only a single group of shutters. In other embodiments, the grille 12 could include any other number and/or configuration of grille-frames and openings, and the shutter assembly 24 could include any other number and/or configuration of shutters or groups of shutters. While the shutters 28, 30 are shown in the figures as extending generally vertically, in some embodiments, the shutters 28, 30 could extend horizontally across a width of the openings 15, 17.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. An assembly comprising:
a frame member including an opening extending therethrough;
a shutter mounted for movement relative to the frame member between a first position allowing airflow through the opening and a second position restricting airflow through the opening; and
a seal member disposed between the frame member and the shutter and contacting the frame member and the shutter when the shutter is in the second position to restrict airflow between the frame member and the shutter.

2. The assembly of claim 1, wherein the shutter includes a longitudinal edge having another seal member that contacts an adjacent shutter in the second position.

3. The assembly of claim 1, wherein the seal member extends around an entire periphery of the opening.

4. The assembly of claim 1, wherein the frame member is mounted to a vehicle, and wherein wind resistance biases the seal member against the shutter when the vehicle is moving in a forward direction and the shutter is in the second position.

5. The assembly of claim 1, wherein the frame member is a grille-surround.

6. The assembly of claim 5, wherein the seal member is fixedly attached to the frame member.

7. The assembly of claim 6, wherein the shutter is rotatable about a rotation axis extending between upper and lower portions of the frame member, and wherein the seal member is attached to at least one of the upper and lower portions and contacts a surface of the shutter facing the opening in the second position.

8. The assembly of claim 1, wherein the seal members include a fixed end and a free end, the fixed end being attached to an inner lip portion of the frame member, and the free end contacting the shutter when the shutter is in the closed position.

9. An assembly comprising:
a frame member defining an opening;
a plurality of shutters mounted for movement relative to the frame member between a first position allowing airflow through the opening and a second position restricting airflow through the opening; and
a seal member disposed between the frame member and the plurality of shutters and spanning a width of the plurality of shutters, the seal member contacting the frame member and the plurality of shutters when the plurality of shutters are in the second position.

10. The assembly of claim 9, wherein each of the shutters include a longitudinal edge having another seal member that contacts an adjacent shutter in the second position.

11. The assembly of claim 9, wherein the seal member extends around an entire periphery of the opening.

12. The assembly of claim 9, wherein the frame member is mounted to a vehicle, and wherein wind resistance biases the seal member against the shutters when the vehicle is moving in a forward direction and the shutters are in the second position.

13. The assembly of claim 9, wherein the frame member is a grille-surround.

14. The assembly of claim 13, wherein the seal member is fixedly attached to the frame member.

15. The assembly of claim 9, wherein the shutters are rotatable about a rotation axis extending between upper and lower portions of the frame member, and wherein the seal member is attached to at least one of the upper and lower portions and contacts surfaces of the shutters facing the opening in the second position.

16. The assembly of claim 9, wherein the seal members include a fixed end and a free end, the fixed end being attached to an inner lip portion of the frame member, and the free end contacting the shutter when the shutter is in the closed position.

17. A grille shutter assembly comprising:
a frame member defining an opening;
a plurality of shutters mounted for movement relative to the frame member between a first position allowing airflow through the opening and a second position restricting airflow through the opening,
a first seal member disposed on a longitudinal edge of one of the shutters and contacting an adjacent one of the shutters when the shutters are in the closed position; and
a second seal member configured to be mounted to an inner lip portion of a grille-surround and contacting the shutters when the shutters are in the second position.

18. The grill shutter assembly of claim 17, wherein the second seal member include a fixed end and a free end, the fixed end being attached to the inner lip portion of the grille-surround, and the free end contacting the shutters when the shutters are in the closed position.

19. The grille shutter assembly of claim 18, wherein the frame member is mounted to a vehicle, and wherein wind resistance biases the seal member against the shutters when the vehicle is moving in a forward direction and the shutters are in the second position.

20. The grille shutter assembly of claim 19, wherein the second seal member extends around an entire periphery of the opening.
